(19) United States
(12) Patent Application Publication
(10) Pub. No.: US 2025/0370848 A1
(43) Pub. Date: Dec. 4, 2025

(54) ROOT-CAUSE DETECTION BASED ON AUTOMATED RESOLUTION OF DEPENDENCIES BETWEEN HETEROGENEOUS ISSUES

(71) Applicant: Cisco Technology, Inc., San Jose, CA (US)

(72) Inventors: Marco Trinelli, Lausanne (CH); Frank Brockners, Köln (DE); Trevor Adam Whinmill, Nuneaton (GB); Pablo García del Valle, Chavannes-près-Renens (CH)

(73) Assignee: Cisco Technology, Inc., San Jose, CA (US)

(21) Appl. No.: 19/091,039

(22) Filed: Mar. 26, 2025

Related U.S. Application Data
(60) Provisional application No. 63/652,880, filed on May 29, 2024.

(51) Int. Cl. G06F 11/07

(52) U.S. Cl. CPC G06F 11/079; G06F 11/0709

(57) ABSTRACT

In one implementation, a device may obtain natural language descriptions of issues detected in a computing system. The device may prompt one or more language models to generate sets of possible causal dependencies between the issues based on their natural language descriptions. The device may form, using the one or more language models, an issue dependency graph that reaches consensus among the sets of possible causal dependencies between the issues. The device may use the issue dependency graph to determine a particular one of the issues as a root cause of an indicated problem in the computing system.

### RELATED APPLICATION

The application claims priority to U.S. Prov. Appl. Ser. No. 63/652,880, filed May 29, 2024, for ROOT-CAUSE DETECTION BASED ON AUTOMATED RESOLUTION OF DEPENDENCIES BETWEEN HETEROGENEOUS ISSUES, by Trinelli, et al., the contents of which are incorporated herein by reference.

### TECHNICAL FIELD

The present disclosure relates generally to computer networks, and, more particularly, to root-cause detection based on automated resolution of dependencies between heterogeneous issues.

### BACKGROUND

Troubleshooting highly distributed and heterogenous environments can be a challenging undertaking. By nature, distributed system components have dependencies on other components. Therefore, an issue of one of those components can affect many other components. In such cases, numerous components may report issues.

An engineer troubleshooting the situation faces the challenge of determining the root cause of the numerous reports. However, manually determining the dependencies and performing root cause analysis may be very difficult in such a scenario, given that identifiers of the components, even if they exist, are distributed across different system architectural layers, and/or non-synchronized namespaces. This process is not only time consuming but also prone to errors.

Further, manual troubleshooting becomes increasing inefficient as the size of the system and number of components grow. Accordingly, under this regime, increases in system downtime, outages, resource misallocations, inconsistent user experiences, operational inefficiencies, maintenance and supports costs, and security vulnerability exposures are observed as the size of the system and number of components grow. Given the ever-increasing use and complexity of distributed environments and the mounting failures of the manual approach to parsing dependencies, conventional approaches to root cause detection are no longer adequate.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of an architecture for root cause detection;

FIG. 4 illustrates an example of a procedure for generating a dependency graph from inputs to a root cause detector;

FIG. 5 illustrates an example of a procedure for relevant root cause retrieval from inputs to a root cause detector;

FIG. 6 illustrates an example of an output dependency graph generated by a root cause detector; and

FIG. 7 illustrates an example of a simplified procedure for root-cause detection, in accordance with one or more implementation described herein.

### DESCRIPTION OF EXAMPLE IMPLEMENTATIONS

### Overview

According to one or more implementations of the disclosure, a device may obtain natural language descriptions of issues detected in a computing system. The device may prompt one or more language models to generate sets of possible causal dependencies between the issues based on their natural language descriptions. The device may form, using the one or more language models, an issue dependency graph that reaches consensus among the sets of possible causal dependencies between the issues. The device may use the issue dependency graph to determine a particular one of the issues as a root cause of an indicated problem in the computing system.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

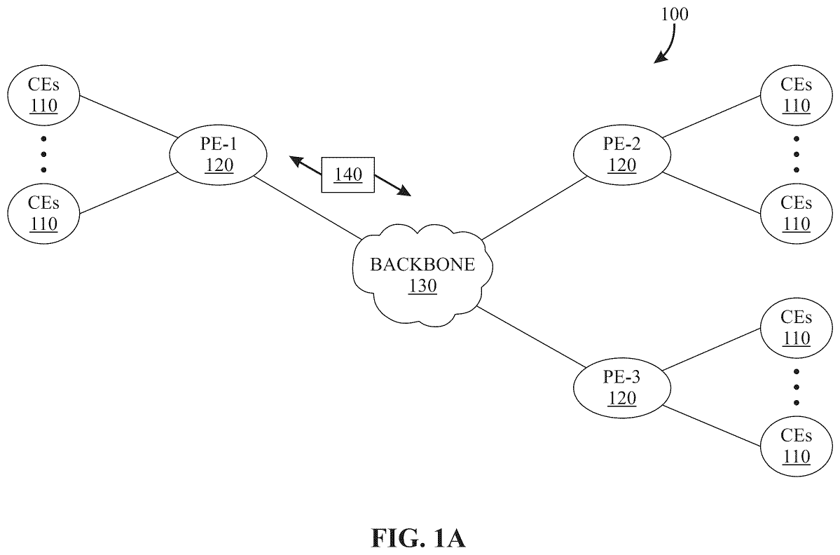

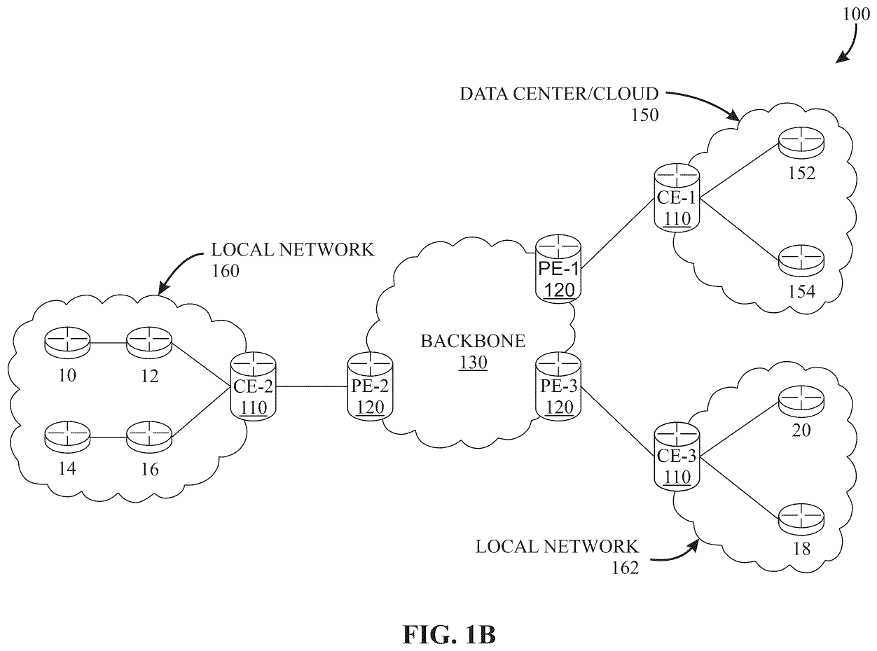

FIG. 1A is a schematic block diagram of an example computer network 100 illustratively comprising nodes/devices, such as a plurality of routers/devices interconnected by links or networks, as shown. For example, customer edge (CE) routers (e.g., CE router(s) 110) may be interconnected with provider edge (PE) routers (e.g., PE router(s) 120) (e.g., PE-1, PE-2, and PE-3) in order to communicate across a core network, such as an illustrative network backbone (e.g., network backbone 130). For example, CE router(s) 110, PE router(s) 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router(s) 110 shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).
Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., CE router(s) 110) connected to PE-2 and a second CE router (e.g., CE router(s) 110) connected to PE-3.

FIG. 1B illustrates an example of computer network 100 in greater detail, according to various implementations. As shown, network backbone 130 may provide connectivity between devices located in different geographical areas and/or different types of local networks. For example, computer network 100 may comprise local/branch networks (e.g., network 160, network 162) that include devices/nodes 10-16 and devices/nodes 18-20, respectively, as well as a data center/cloud environment 150 that includes servers 152-154. Notably, local networks (e.g., network 160, network 162) and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in computer network 100 to connect local network (e.g., network 160), local network (e.g., network 162), and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network (e.g., network 160) to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network (e.g., network 160) and data center/cloud environment 150 on top of the various underlying connections. Another feature of SD-WAN is centralized management by a supervisory service that can monitor and adjust the various connections, as needed.

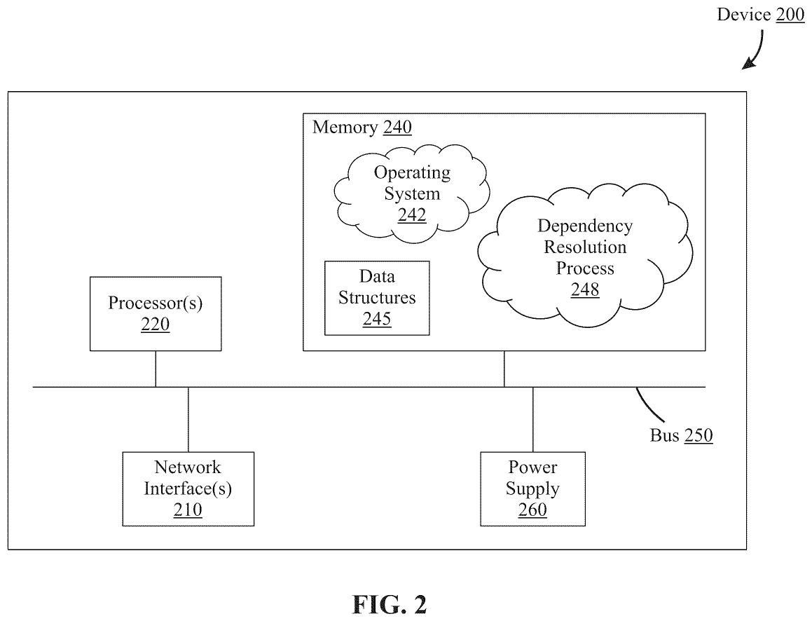

FIG. 2 is a schematic block diagram of an example node/device 200 (e.g., an apparatus) that may be used with one or more implementations described herein, e.g., as any of the computing devices shown in FIGS. 1A-1B, particularly the PE router(s) 120, CE router(s) 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more of network interfaces 210, one or more of processor(s) 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a dependency resolution process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, dependency resolution process 248 may include computer executable instructions that, when executed by processor(s) 220, cause device 200 to perform the techniques described herein. To do so, in some implementations, dependency resolution process 248 may utilize and/or involve operations of machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, dependency resolution process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance, sample component, communication, or relationship data indicative of dependencies between components, sample dependency graphs indicative of dependencies between components, etc. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that dependency resolution process 248 can employ and/or involve may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, dependency resolution process 248 may also include and/or involve the operations of one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, dependency resolution process 248 may use a generative model to generate synthetic network traffic based on existing user traffic to test how the network reacts, generate direct acyclic graphs, etc. Example generative approaches can include, but are not limited to, generative adversarial networks (GANs), large language models (LLMs), other transformer models, and the like.

As noted above, troubleshooting highly distributed and heterogenous environments is challenging given that distributed system components have dependencies on other components. Consequently, an issue of one of those components can affect many other components. In such a case, numerous components will report issues.

Consider a Kubernetes-based microservice application as an example: a failure at the network level can result in issues being reported by Kubernetes (e.g., “image pull backoff error”), and issues by Pods/applications, like the backend cannot reach the catalogue or database service. In such a situation many entities will observe issues and an IT engineer troubleshooting the situation faces the challenge of determining the root cause. Manually determining the dependencies and performing root cause analysis is very difficult in such a scenario, given that identifiers of the components, even if they exist, are distributed across different system architectural layers, and non-synchronized namespaces.

Consequently, this error-prone and inelastic approach yields increasing root cause identification delays and failures as the amount and relational complexity of the constituent components in distributed environments continues to increase. These failures translate to increased system downtime, outages, resource misallocations, inconsistent user experiences, operational inefficiencies, maintenance and supports costs, security vulnerability exposures, etc.

### Root-Cause Detection Based on Automated Resolution of Dependencies Between Heterogeneous Issues

In contrast, the techniques herein introduce a mechanism to generate and present a support engineer with a bundle (a.k.a. “tar ball) of different files that describe an issue that the engineer is tasked with resolving. That is, rather than having the support engineer scan the files manually and determine relationships manually, these techniques automate the process in a manner that supports multi-domain deployments, accommodating deployments of customers that span multiple locations and/or domains, including on-premises and cloud. Further, these techniques support multi-vendor deployments, accommodating devices and/or entities deployed from different vendors. Furthermore, these techniques support root cause analysis in an unsupervised manner without a need for custom-pretraining of models. Customization of a solution can add toil and cost for the customer. These techniques are instead generically applicable to any customer deployment and do not require customization, like calibrating/training the system with data from a “stable, non-errored case”, etc.

Illustratively, the techniques described herein may be performed by hardware, software, and/or firmware, such as in accordance with dependency resolution process 248, which may include computer executable instructions executed by the processor(s) 220 (or independent processor of network interfaces 210) to perform functions relating to the techniques described herein.

Specifically, according to various implementations, a device may obtain natural language descriptions of issues detected in a computing system. The device may prompt one or more language models to generate sets of possible causal dependencies between the issues based on their natural language descriptions. The device may form, using the one or more language models, an issue dependency graph that reaches consensus among the sets of possible causal dependencies between the issues. The device may use the issue dependency graph to determine a particular one of the issues as a root cause of an indicated problem in the computing system.

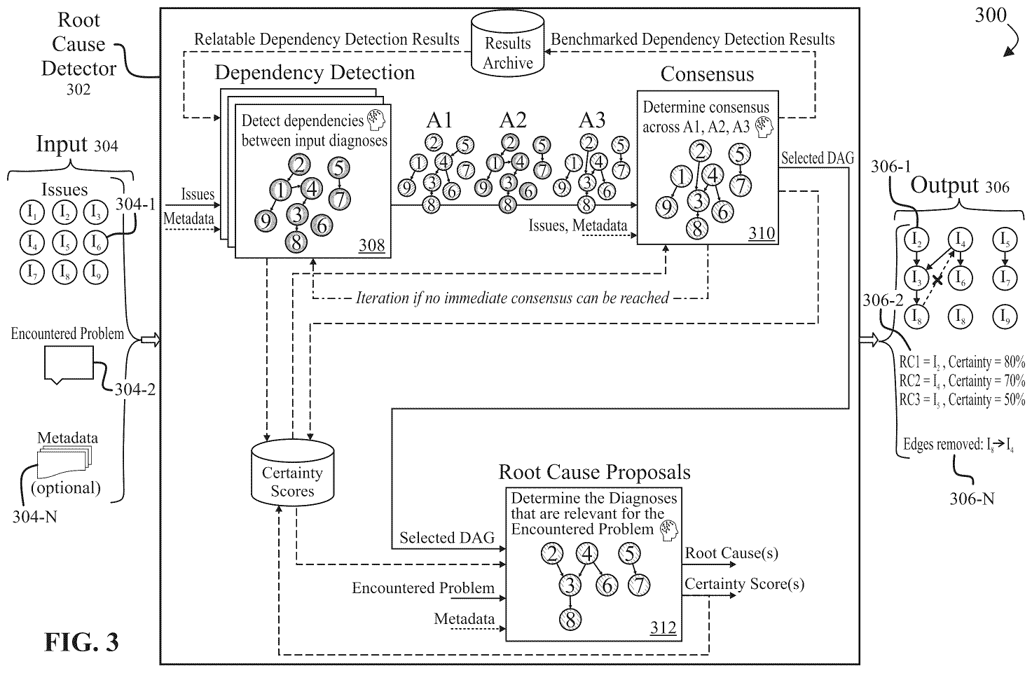

Operationally, FIG. 3 illustrates an example of an architecture 300 for root cause detection, in accordance with one or more implementation described herein. Architecture 300 may include a root cause detector 302. Root cause detector 302 may be instantiated on and/or executed by one or more apparatus. The apparatus may include one or more network interfaces to communicate with a network, a processor coupled to the one or more network interfaces and configured to execute one or more processes, and/or a memory configured to store a process (e.g., dependency resolution process 248) that is executable by the processor to perform root cause detection operations (e.g., dependency detection operation 308, consensus operation 310, relevant root causes retrieval operation 312, etc.).

In some instances, root cause detection operations may be a result of a distributed processes, distributed process executions, etc. occurring across more than one physical or logical machine. The root cause detector 302 may be offered as a standalone product or service (e.g., as a cloud service, lambda function, etc.).

The root cause detector 302 may utilize language model (e.g., large language model (LLM), etc.) assisted mechanisms to provide suggestions for a root cause about failures in a distributed system. The root cause detector 302 may first obtain inputs 304. The inputs 304 may include a list of issues 304-1 (I) that describes problems experienced by a system. The issues may be described in natural language. If an issue is not described in natural language (e.g., by a sequence of logs), an LLM can be used to translate the issue description into natural language.

Additionally, inputs 304 may include an encountered problem 304-2 (P) experienced by a user while using the distributed system. P may also be expressed as text in natural language (e.g., “The catalog of my web shop is not available”). Optionally, inputs 304 may include metadata 304-N that may help the mechanisms involved in root-cause detection. Metadata 304-N could be data generated by an ETL (Extract, Transform, Load) pipeline and/or be generated by a human. Metadata 304-N may include, for example, network topology information, configuration files of the service in the distributed system, etc.

Root cause detector 302 may generate outputs 306. Outputs 306 may include a dependency graph output as a Direct Acyclic Graph 306-1 (DAG) that shows the cause-effect relations between the input issues that are relevant for the Encountered Problem. In addition, outputs 306 may include a list of root-causes 306-2 RC(i). For each RC(i) a certainty-indicator (e.g., certainty-score CS(i)) may be provided. Further, outputs 306 may include an indicator 306-N describing whether some edges that were forming a cycle in the original dependency graph have been removed to construct the DAG.

Root cause detector 302 may utilize various mechanisms described herein (e.g., dependency detection operation 308, consensus operation 310, relevant root causes retrieval operation 312, etc.) for detecting possible root causes among the list of issues I that are relevant for the encountered problem P. Each root cause may be accompanied with a certainty indicator (e.g., certainty score), which may be determined by a combination of scores from previous runs on similar issues and/or scores generated by the LLM in different steps.

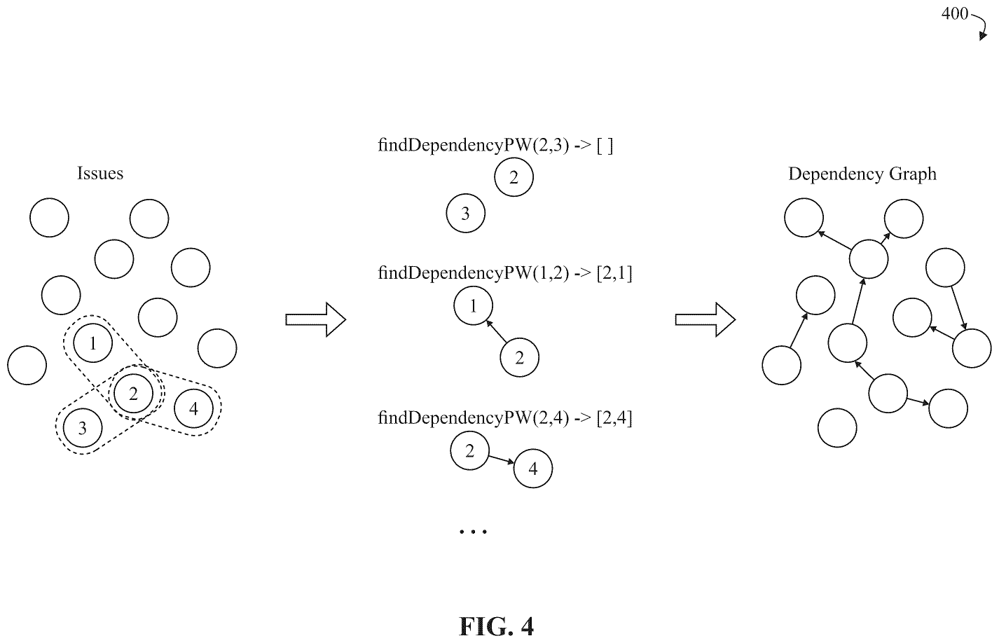

FIG. 4 illustrates an example of a procedure 400 for generating a dependency graph from inputs to a root cause detector, in accordance with one or more implementation described herein. Initially, a dependency detection operation may be performed. This may include the submission of queries to a language model (e.g., large language model (LLM)) to determine dependencies between the input issues. Language models may achieve highly accurate results on causal reasoning tasks such as these.

Relatable dependencies detected against similar issues from previous runs (results archive) can be leveraged using One-Shot/Few-Shot prompt engineer techniques, leveraging a language model's ability to use previous examples to influence and improve the detection results within the context of new issues.

Determining the dependencies using a language model may be achieved using one or more of a variety of approaches. For example, a single prompt approach may be utilized whereby the entire list of issues may be submitted to the language model and the language model may be asked to find all dependencies between all issues I. Alternatively, or additionally, a pairwise approach may be utilized whereby the language model is asked to find dependencies between pairs of issues. For example, for all (i, j), determine whether I(i) depends on I(j) or vice versa. This pairwise approach may lead to higher accuracy and consistency.

A dependency graph that includes cycles may not be used for root cause analysis. So, a mechanism may be implemented to transform the dependency graph to be a DAG (Direct Acyclic Graph). This mechanism may include, for example, ignoring graphs with cycles as part of the consensus building operation, break the cycle by randomly removing an edge part of the cycle, ask a language model which is edge should be removed to break the cycle, merge the nodes of the cycle into a compound node and summarize their issues, etc.

Detecting dependencies (e.g., by pairwise approach, by single prompt approach, etc.) may produce slightly different results in subsequent runs, despite using the same input. To determine which of these answers to consider valid, a consensus mechanism may be utilized (e.g., a language model-assisted consensus building operation). For instance, a consensus mechanism may leverage a consensus algorithm that is based on mathematical and statistical method. These algorithms may be a function of edges E only, and so they may not consider the semantics of the dependency. For example, in a first step a language model may return an answer a (E, d) that includes the list of edges (E) and a description (d). Such a description may contain the rationale behind the list of edges E produced by the language model.

In various implementations, rather than using a mathematical or statistical consensus mechanism, the techniques herein may use one or more LLMs or other language models to reach consensus among the dependencies. Such a language model-assisted consensus mechanism may, given N answers A[n] with each one including the list of dependencies E and their rationale d, return the answer a (E, d) among A[n] which reaches consensus. Optionally, may also be possible to include the list of issues I if we want the LLM to check the dependencies against the individual issues.

The consensus results may also be utilized to gate archiving detected issue dependencies based upon a benchmarked certainty indicator (e.g., certainty score) threshold. The issue descriptions for selected dependency results may be cleaned and generalized for reference within future language model dependency detection requests against semantically relatable issues.

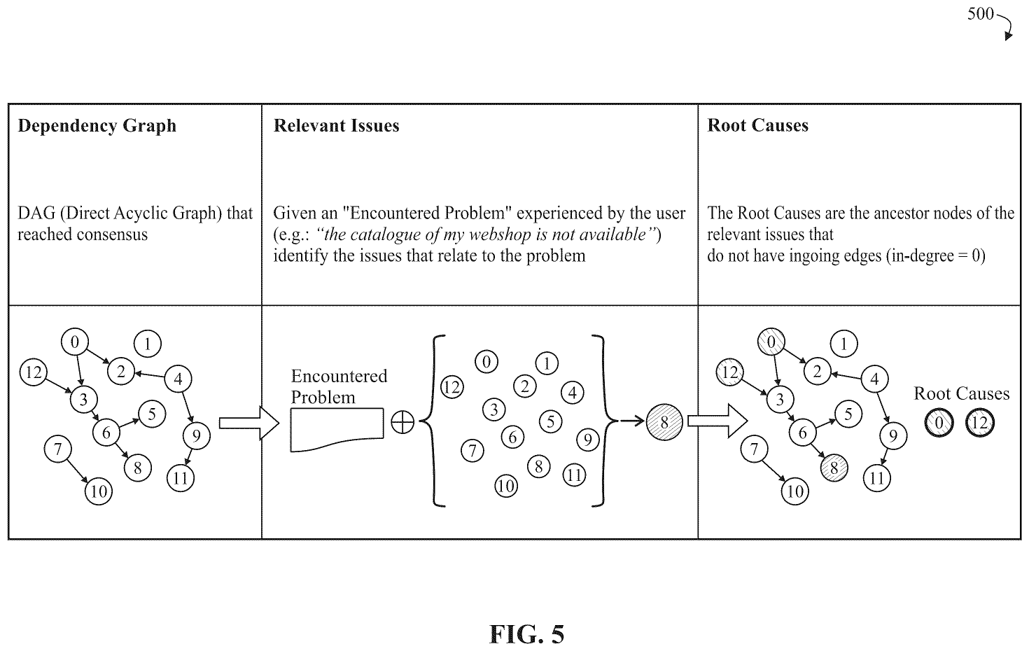

FIG. 5 illustrates an example of a procedure 500 for relevant root cause retrieval from inputs to a root cause detector, in accordance with one or more implementation described herein. At this point, a dependency graph as a DAG may be formed, with n nodes I and edges E as the derived relationships that reached consensus.

In a typical scenario, where there are issues very different to each other, there are several potential root nodes (and so root causes) but some of them could be irrelevant for the issue experienced by the user, namely the encountered problem P. For example, imagine issues associated with vulnerable secure shell (SSH) keys while the encountered problem by the user is about a web app going down.

Hence, a language model-assisted mechanism may be utilized to retrieve only root causes that are relevant for P. The language model, given the encountered problem P and original list of issues with their diagnosis I, may identify the issues RI, part of the DAG, that are relevant for the encountered problem. After that, the relevant root causes may be the ancestors of RI that do not have incoming edges (i.e., all nodes that are root nodes of the DAG and ancestors of the relevant issues RI).

Of note, in procedure 500, Issue 4 is a root node of the DAG but is not a relevant root cause as there is no path between Issue 4 and Issue 8. Also, if Issue 10 was part of the relevant issues RI, Issue 7 would also have been one more root cause, alongside Issue 0 and Issue 12.

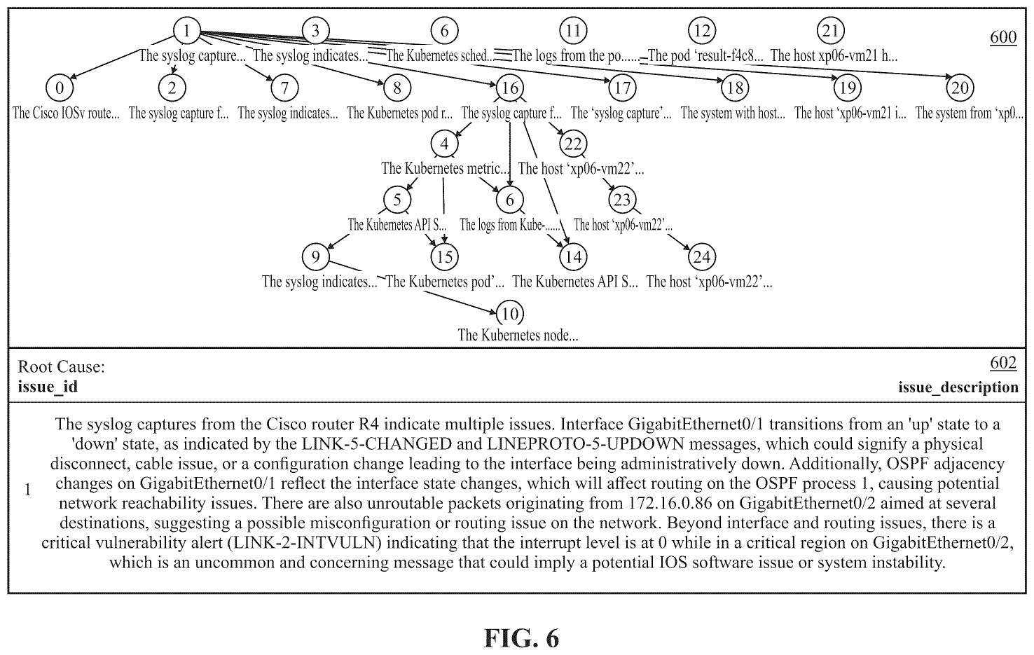

FIG. 6 illustrates an example of an output dependency graph 600 generated by a root cause detector, in accordance with one or more implementation described herein. The output dependency graph 600 may be accompanied with a description 602 of the root cause. The root cause detector may be unique in the way that it takes a set of issue descriptions (e.g., in natural language) and a problem statement as input and produces a set of potential root-causes as output. The root cause detector does not necessarily distill tags or require that an input is structured into semantic or syntactic tags. The output root-causes may be accompanied by a certainty indicator and the dependency graph—which may further differentiate the root cause detector from root-cause analysis solutions that use deterministic expert systems.

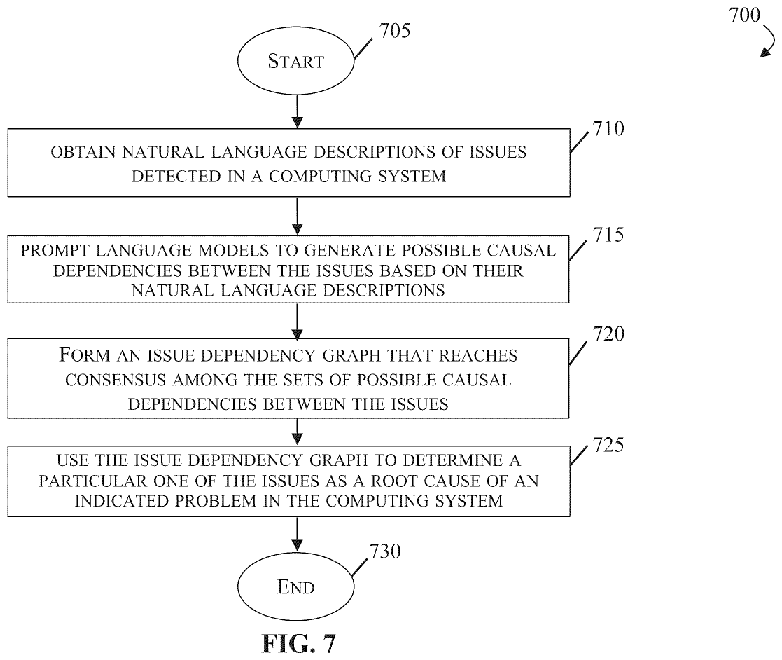

FIG. 7 illustrates an example of a simplified procedure for root-cause detection, in accordance with one or more implementations described herein. For example, a non-generic, specifically configured device (e.g., device 200), may perform procedure 700 (e.g., a method) by executing stored instructions (e.g., dependency resolution process 248).

The procedure 700 may start at step 705, and continues to step 710, where, as described in greater detail above, the device (e.g., a controller, processor, etc.) may obtain natural language descriptions of issues detected in a computing system. The natural language descriptions of the issues in the computing system may be obtained by causing a language model to translate a sequence of logs into the natural language descriptions.

In various implementations, metadata may be obtained as well. This metadata may include network topology information and/or configuration files of a service in the computing system.

At step 715, as detailed above, a device may prompt one or more language models to generate sets of possible causal dependencies between the issues based on their natural language descriptions.

At step 720, as detailed above, a device may form, using the one or more language models, an issue dependency graph that reaches consensus among the sets of possible causal dependencies between the issues. The consensus may be reached based on a correspondence between the dependencies that are detected between the issues across a plurality of anomaly dependency detection runs by the language model.

The issue dependency graph (e.g., the configuration of the graph, the arrangement of elements in the graph, the logical relationships established by the graph, etc.) may be based on natural language descriptions of rationales behind a list of edges produced by the one or more language models for the consensus among the sets of possible causal dependencies between the issues.

Forming the issue dependency graph that reaches consensus among the sets of possible causal dependencies between the issues may include generating a direct acyclic graph (DAG) by removing edges forming a cycle in an initial graph of possible causal dependencies between the issues. Therefore, the graph may be a DAG that shows the cause-effect relations between the input issues that are relevant for the issues.

In various implementations, the language model may be configured to exclude potential root nodes in the issue dependency graph of the possible causal dependencies between the issues from root cause candidacy based on their relevancy to the issue encountered by the user of the computing system.

At step 725, as detailed above, the device may use the issue dependency graph to determine a particular one of the issues as a root cause of an indicated problem in the computing system. In various implementations, the root cause of the problem encountered by a user of the computing system may be identified further based on the metadata. In some examples, a language model may be utilized to use the issue dependency graph to determine a particular one of the issues as a root cause of an indicated problem in the computing system.

In some instances, a certainty indication indicating a strength of a causal dependency associated with the root cause may be determined. The issue dependency graph, a description of the root cause, and/or the certainty indication associated with the root cause may be caused to be displayed to a user via a user interface.

In some instances, the consensus among the sets of possible causal dependencies between the issues may be utilized to gate (e.g., control) archiving of detected issued dependencies for future dependency detection requests based on a relationship of the certainty indication to a certainty indication threshold. The archived results (e.g., from previous runs) may be reused in future investigations. That is, the results (e.g., output) of each block could be re-used as an input of other blocks across the flow, so as to effectuate a feedback mechanism.

In various implementations, the device may provide an indication for display that the particular one of the issues is the root cause. For example, the device may output a dependency graph and/or a description of the issue that has been identified as a root cause.

Procedure 700 then ends at step 730.

It should be noted that while certain steps within procedure 700 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a root-cause identification system that is probabilistic in nature and that organizes observed issues into a dependency graph to arrive at potential root-causes. Different from classic root-cause analysis systems that are based on expert systems, the described system may expose the decision tree along with a certainty-indicator (e.g., certainty-score) to a user, that allows the user to understand the quality of the result—as well as offers alternatives.

In various implementations, an LLM-assisted consensus mechanism may be utilized for causal reasoning scenarios, which considers the rationale of dependencies to determine consensus. In addition, use automated LLM-assisted mechanisms may be utilized to retrieve relevant root causes for a problem experienced by the user. For each root cause, a certainty indicator (certainty scores) may be provided, which may be a combination of scores from previous runs on similar input issues and/or scores generated by the LLM in different internal steps.

The proposed root cause detector may be integrated in a system to work “on-demand” mode, rather than in “streaming” mode. This may mean that the functionalities performed by the root cause detector are triggered by a user (e.g., via REST APIs or gRPC calls). The root cause detector may be run in a “streaming” mode with consideration of dependencies and constraints such as real-time detection of a trigger point to execute the root cause detector, positioning the execution at an appropriate point correlating to sufficient capture of issues within the streamed data. The real-time trigger point may need to be provided as a pre-processing step performed across the input stream, offered as a service by stream processing platforms (i.e., Splunk).

Additionally, the root cause detector may be run in a “streaming” mode with consideration of dependencies and constraints such as the current performance limitations of the language models (e.g., LLMs), resulting in variable prompt completion time frames, across a broad range of prompt invocations operated by the root cause detector. In some instances, language model performance limitations may constrain the integration of the root cause detector to an asynchronous processing stage within a sequential pipeline. However, some language models may offer more real-time integration options within a “streaming” mode context (e.g., interfacing with the user with WebSockets, HTTP Long Polling, gRPC streaming, etc.).

Given multi-domain and heterogenous diagnoses in natural language, the techniques described herein may produce candidate root causes related to an issue encountered by the user. Each root cause may be accompanied by a certainty indicator (e.g., score, etc.), indicating how reliable the detection is, and/or the acyclic dependency graph (DAG), indicating the relationships between the issues. This approach will expedite and increase the accuracy of root cause identification for detected issues. This Accordingly, these techniques will yield decreases in system downtime, outages, resource misallocations, inconsistent user experiences, operational inefficiencies, maintenance and supports costs, and security vulnerability exposures.

While there have been shown and described illustrative implementations that facilitate root-cause detector based on automated resolution of dependencies between heterogenous issues, it is to be understood that various other adaptations and modifications may be made within the spirit and scope of the implementations herein. For example, while certain implementations are described herein with respect to using certain elements, modules, components, architectures, etc. for the purposes of root-cause detection based on automated resolution of dependencies between heterogenous issues, the elements, modules, components, architectures, etc. are not limited as such and may be used for other functions, in other arrangements, in other functional distributions, in other implementations, etc.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software (e.g., computer-executable instructions) being stored on a tangible (non-transitory) computer-readable medium (e.g., disks/CDs/RAM/EEPROM/etc. with computer-executable instructions stored thereon) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
obtaining, by a device, natural language descriptions of issues detected in a computing system;
prompting, by a device, one or more language models to generate sets of possible causal dependencies between the issues based on their natural language descriptions;
forming, by the device and using the one or more language models, an issue dependency graph that reaches consensus among the sets of possible causal dependencies between the issues; and
using, by the device, the issue dependency graph to determine a particular one of the issues as a root cause of an indicated problem in the computing system.

2. The method of claim 1, wherein the natural language descriptions of the issues in the computing system is obtained by causing a language model to translate a sequence of logs into the natural language descriptions.

3. The method of claim 1, further comprising:
obtaining metadata including one or more of network topology information or configuration files of a service in the computing system.

4. The method of claim 3, wherein the root cause of the indicated problem encountered by a user of the computing system is identified further based on the metadata.

5. The method of claim 1, further comprising:
determining a certainty indication indicating a strength of a causal dependency associated with the root cause.

6. The method of claim 5, further comprising:
causing the issue dependency graph, a description of the root cause, and the certainty indication associated with the root cause to be displayed to a user via a user interface.

7. The method of claim 1, further comprising:
reusing archived sets of possible causal dependencies between issues identified in previous dependency detection request runs as inputs to influence future dependency detection request runs.

8. The method of claim 1, wherein the issue dependency graph is based on natural language descriptions of rationales behind a list of edges produced by the one or more language models for the consensus among the sets of possible causal dependencies between the issues.

9. The method of claim 1, wherein forming the issue dependency graph that reaches consensus among the sets of possible causal dependencies between the issues includes generating a direct acyclic graph by removing edges forming a cycle in an initial graph of possible causal dependencies between the issues.

10. The method of claim 1, further comprising:
providing an indication for display that the particular one of the issues is the root cause.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
obtain natural language descriptions of issues detected in a computing system;
prompt one or more language models to generate sets of possible causal dependencies between the issues based on their natural language descriptions;
form, using the one or more language models, an issue dependency graph that reaches consensus among the sets of possible causal dependencies between the issues; and
use the issue dependency graph to determine a particular one of the issues as a root cause of an indicated problem in the computing system.

12. The apparatus as in claim 11, wherein the natural language descriptions of the issues in the computing system is obtained by causing a language model to translate a sequence of logs into the natural language descriptions.

13. The apparatus as in claim 11, the process further configured to:
obtain metadata including one or more of network topology information or configuration files of a service in the computing system.

14. The apparatus as in claim 13, wherein the root cause of the indicated problem encountered by a user of the computing system is identified further based on the metadata.

15. The apparatus as in claim 11, the process further configured to:
determine a certainty indication indicating a strength of a causal dependency associated with the root cause.

16. The apparatus as in claim 15, the process further configured to:
cause the issue dependency graph, a description of the root cause, and the certainty indication associated with the root cause to be displayed to a user via a user interface.

17. The apparatus as in claim 11, the process further configured to:
reuse archived sets of possible causal dependencies between issues identified in previous dependency detection request runs as inputs to influence future dependency detection requests runs.

18. The apparatus as in claim 11, wherein the issue dependency graph is based on natural language descriptions of rationales behind a list of edges produced by the one or more language models for the consensus among the sets of possible causal dependencies between the issues.

19. The apparatus as in claim 11, wherein the issue dependency graph is a direct acyclic graph generated by removing edges forming a cycle in an initial graph of possible causal dependencies between the issues, and wherein a language model uses the issue dependency graph to determine the particular one of the issues as the root cause of the indicated problem in the computing system.

20. A tangible, non-transitory, computer-readable medium having computer-executable instructions stored thereon that, when executed by a processor on a computer, cause the computer to perform a method comprising:
obtaining natural language descriptions of issues detected in a computing system;
prompting one or more language models to generate sets of possible causal dependencies between the issues based on their natural language descriptions;
forming, using the one or more language models, an issue dependency graph that reaches consensus among the sets of possible causal dependencies between the issues; and
using the issue dependency graph to determine a particular one of the issues as a root cause of an indicated problem in the computing system.
